(19) United States
(12) Patent Application Publication
(10) Pub. No.: US 2023/0035401 A1
(43) Pub. Date: Feb. 2, 2023

(54) DATA PRODUCT GENERATION AND PRODUCTION BASED ON DYNAMICALLY SELECTED/OBFUSCATED VEHICLE LOCATION

(71) Applicant: Wejo Limited, Manchester (GB)

(72) Inventor: Stuart CONSTANTINE, Liverpool (GB)

(21) Appl. No.: 17/381,803

(22) Filed: Jul. 21, 2021

(51) Int. Cl. G08G 1/01; B60W 40/105; B60W 40/06; G08G 1/052

(52) U.S. Cl. CPC G08G 1/0112; G08G 1/0137; B60W 40/105; B60W 40/06; G08G 1/052; B60W 2756/10; B60W 2552/05

(57) ABSTRACT

A system configured to, and method of, generating and providing a data product using data supplied by a multitude of vehicles that includes receiving a plurality of geographical locations; carrying out a geographical location obfuscation process in order to obtain processed connected vehicle data, wherein the geographical location obfuscation process includes: (i) identifying a road segment based on the received geographical location; (ii) determining an associated road type of the road segment; (iii) determining whether to obfuscate the received geographical location based at least in part on the associated road type; and (iv) when it is determined to obfuscate the received geographical location, obfuscating the received geographical location so as to obtain an obfuscated geographical location, wherein the obfuscated geographical location is included in the processed connected vehicle data; generating the data product using the processed connected vehicle data; and providing the data product to a third party.

### TECHNICAL FIELD

This invention relates to methods and systems for streaming data from a very large number of vehicles to a remote data repository and generating data products based on the streaming data in real-time.

### BACKGROUND

Nowadays, large amounts of data are streamed from automobiles and other vehicles, and this data is used for various purposes, such as for providing traffic conditions of roads. Some vehicle data, such as its geographical position or location, is included in these vehicle data streams that are transmitted to a remote system, which may then store the data and/or package the data into a data product. To protect privacy, certain vehicle data may be anonymized.

### SUMMARY

According to one aspect of the invention, there is provided a data product system for generating and providing a data product using data supplied by a multitude of vehicles, wherein each of the multitude of vehicles includes vehicle electronics configured to: periodically obtain a current geographical location of the vehicle; and in response to obtaining the obtained geographical location of the vehicle, transmit the obtained geographical location of the vehicle to a remote location; wherein the data product system comprises one or more electronic processors and memory storing data product computer instructions accessible by the one or more electronic processors of the data product system; wherein the data product system is configured so that, when the data product computer instructions are executed by the one or more electronic processors of the data product system, the data product system: receives a plurality of connected vehicle data sets that include a plurality of received geographical locations including the obtained geographical location, wherein each of the plurality of connected vehicle data sets was transmitted by one of the multitude of vehicles; carries out a geographical location obfuscation process in order to obtain processed connected vehicle data, wherein the geographical location obfuscation process includes processing each of the plurality of received geographical locations by: (i) identifying a road segment from a plurality of road segments based on the received geographical location; (ii) determining an associated road type of the road segment; (iii) determining whether to obfuscate the received geographical location based at least in part on the associated road type; and (iv) when it is determined to obfuscate the received geographical location, obfuscating the received geographical location so as to obtain an obfuscated geographical location, wherein the obfuscated geographical location is included in the processed connected vehicle data; generates the data product using the processed connected vehicle data; and provides the data product to a third party.

According to various embodiments, the data product system may further include any one of the following features or any technically-feasible combination of some or all of the features:
the determination of whether to obfuscate the received geographical location includes comparing the associated road type with a predetermined list of road types;
the determination of whether to obfuscate the received geographical location includes determining whether the associated road type is or corresponds to a residential road type;
the obfuscated geographical location is a lower-resolution representation of the received geographical location;
the vehicle electronics are configured to transmit vehicle speed information, and wherein the geographical location obfuscation process includes determining whether to obfuscate the received geographical location based at least in part on the vehicle speed information;
the vehicle speed information indicates a linear vehicle speed of the vehicle;
the geographical location obfuscation process includes, when it is determined that the linear vehicle speed is below a predetermined threshold amount and the associated road type is or corresponds to a residential road type, determining to obfuscate the received geographical location using a first obfuscation level;
the geographical location obfuscation process includes, when it is determined that the linear vehicle speed is above or equal to the predetermined threshold amount and the associated road type is or corresponds to a residential road type, determining to obfuscate the received geographical location using a second obfuscation level, wherein the first obfuscation level is set so that a precision or resolution of the obfuscated geographical location generated using the first obfuscation level is less than a precision or resolution of the obfuscated geographical location generated using the second obfuscation level; and/or
the geographical location obfuscation process includes, when it is determined that the linear vehicle speed is above or equal to the predetermined threshold amount and the associated road type is not or does not correspond to a residential road type, determining not to obfuscate the received geographical location but to include the received geographical location in the processed connected vehicle data.

According to another aspect of the invention, there is provided a method of generating and providing a data product using data supplied by a multitude of vehicles, wherein the method is carried out by a data product system comprising one or more electronic processors, and wherein the method includes the steps of: receiving a plurality of geographical locations, wherein each of the plurality of received geographical locations was transmitted by one of the multitude of vehicles; carrying out a geographical location obfuscation process in order to obtain processed connected vehicle data, wherein the geographical location obfuscation process includes processing each of the plurality of received geographical locations by: identifying a road segment from a plurality of road segments based on the received geographical location; determining an associated road type of the road segment; determining whether to obfuscate the received geographical location based at least in part on the associated road type; and when it is determined to obfuscate the received geographical location, obfuscating the received geographical location so as to obtain an obfuscated geographical location, wherein the obfuscated geographical location is included in the processed connected vehicle data; generating the data product using the processed connected vehicle data; and providing the data product to a third party.

### BRIEF DESCRIPTION OF THE DRAWINGS

Preferred exemplary embodiments will hereinafter be described in conjunction with the appended drawings, wherein like designations denote like elements, and wherein:

FIG. 1 depicts a communications system that includes a data product system and a plurality of vehicles, according to one embodiment;

FIG. 2 depicts a block diagram illustrating components of the communications system of FIG. 1, according to one embodiment;

FIG. 3 is a flowchart of a method of generating and providing a data product using data supplied by a multitude of vehicles, according to one embodiment; and

FIG. 4 is a flowchart of a geographical location obfuscation process, according to one embodiment.

### DETAILED DESCRIPTION

The data product system and method described herein enables generating and providing a real-time data product based on data streams from a multitude of vehicles, where the data streams each include a succession of geographical locations that are accessible to the data product system. According to at least some embodiments, the data product system consumes, processes, and selectively obfuscates or discards geographical locations provided in the data streams from the multitude of vehicles so as to provide a real-time data product while also anonymizing the underlying data so that individual identities of vehicle users are protected. The data product system determines which geographical locations to obfuscate or discard based on a road type of a road segment that the geographical location corresponds to. For example, each of the multitude of vehicles periodically obtains a current geographical location, such as through user of a global navigation satellite system (GNSS) receiver, and then these obtained (current) geographical locations are transmitted to and received at the data product system as a plurality of received geographical locations. As each of the received geographical locations are received at the data product system, the data product system uses a map matching technique to identify a road segment that is closest in geographical proximity to the received geographical location and, based on the road type, the data product system obfuscates or discards the received geographical location so that an obfuscated representation of the received geographical location or data derived therefrom is included in the data product or so that the received geographical location or data derived therefrom is not included in the data product. An example of obfuscation of a geographical location is modifying the geographical location so that it is less precise or has less resolution—e.g., by dropping the last few significant figures or digits.

This is particularly useful for connected vehicles. In some instances, and as alluded to above, it may be desirable to anonymize vehicle location data prior to including that data in a data product so that the streamed data may not be tied to a particular individual. Thus, according to at least some embodiments, the system and method provided herein enable dynamically selecting received geographical locations to be obfuscated or discarded prior to being included in the data product. In at least some embodiments, the data product is provided as a real-time data product that is continuously updated in real-time based on geographical information being received from the multitude of vehicles. A geographical location obfuscation process, which is used to obfuscate or discard received geographical locations, is executed as geographical locations are received from the multitude of vehicles and used as a part of generating and providing a real-time data product as deidentified and/or anonymous data.

As used herein, a “real-time” data product is a data product that is continuously generated and transmitted out to one or more customers as data is received by the product data system. The length of time during which this continuous process occurs may vary depending on the needs of the customer and/or based on other factors. This length of time could be minutes or hours or days at a time. In some embodiments, real-time may refer to the use of “live data” which is defined herein as data for which the mean total time taken by a plurality (two or more) or multitude (1,000 or more) of sequential data points to be transmitted from the vehicle, received at the data product system, and incorporated into (or obfuscated/rejected from) the real-time data product is equal to 120 seconds or less. In some embodiments, the processing carried out at the data product system may be done instantaneously or near-instantaneously, where “instantaneous” means the mean is less than twenty seconds and “near-instantaneous” means the mean is less than forty-five seconds. The instantaneous and near-instantaneous processing may be considered to occur in real-time.

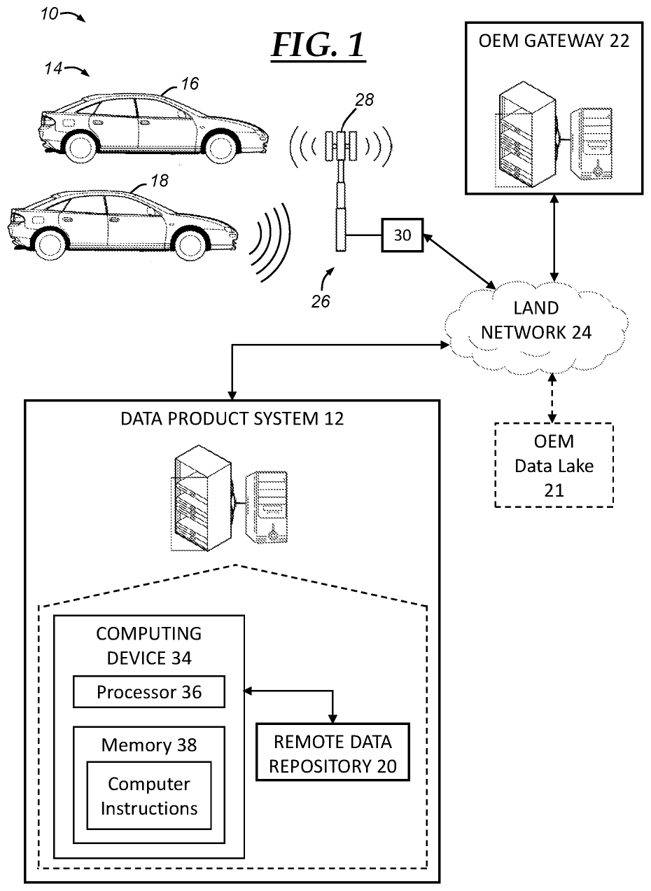

With reference now to FIG. 1, there is shown a communications system 10 that includes a data product system 12, a plurality of vehicles 14 including a first vehicle 16 and a second vehicle 18, an OEM data repository or data lake 21, an OEM gateway 22, a land network 24, and a wireless carrier system 26. Although only two vehicles are shown, it will be appreciated that the system is intended to be capable of working with a multitude of vehicles 14 (i.e., at least 1,000 vehicles) and even with millions of vehicles 14. Also, as used herein, the “vehicles” with which the data product system is used are connected vehicles (CVs) that are capable of wireless communication of data from the vehicle to a data lake or other remote data repository. It should be appreciated that while the illustrated embodiment of FIG. 1 provides an example of one such communications system 10, the data product system 12 and method(s) described below may be used as a part of various other communications systems. Although only one data lake 21 and only one OEM gateway 22 are shown it will be appreciated that the system is intended to work with a multitude of OEM data lakes 21 and OEM gateways 22, several or all of which may be owned and operated by OEMs independent of the OEMs associated with other OEM data lakes 21 and OEM gateways 22.

The land network 24 may be a conventional land-based telecommunications network that is connected to one or more landline telephones and connects the wireless carrier system 26 to the data product system 12, the OEM data lake 21, and the OEM gateway 22. For example, the land network 24 may include a public switched telephone network (PSTN) such as that used to provide hardwired telephony, packet-switched data communications, and the Internet infrastructure. One or more segments of the land network 24 could be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 26 may be any suitable cellular telephone system. The wireless carrier system 26 is shown as including a cellular tower 28; however, the wireless carrier system 26 may include additional cellular towers as well as one or more of the following components (e.g., depending on the cellular technology): base transceiver stations, mobile switching centers, base station controllers, evolved nodes (e.g., eNodeBs), mobility management entities (MMEs), serving and PGN gateways, etc., as well as any other networking components used to connect the wireless carrier system 26 with the land network 24 or to connect the wireless carrier system 26 with user equipment (UEs, e.g., which may include telematics equipment in the vehicles 14), all of which is indicated generally at 30. The wireless carrier system 26 may implement any suitable communications technology, including for example GSM/GPRS technology, CDMA or CDMA2000 technology, LTE technology, 5G, etc. In general, the wireless carrier system 26, its components, the arrangement of its components, the interaction between the components, etc. is generally known in the art.

The remote data repository 20 is used to store data received from the vehicles 14. For example, the vehicles 14 may each be configured to transmit data, which may be a part of a data stream, to the remote data repository 20 via the wireless carrier system 26 and the land network 26. The remote data repository 20, upon receiving the data, may store the data. The remote data repository 20 is shown as a part of the data product system 12, which may be owned and operated by an independent commercial partner of one or more of the vehicle original equipment manufacturers (OEMs). In other embodiments, the data repository may be any publicly or privately accessible aggregation of stored data, which can be structured or unstructured data and which is accessible over a global communications network such as the internet. For example, as optionally shown in FIG. 1, the OEM may have its own data lake (repository) 21 to which the data from the vehicles are initially stored and then accessed (e.g., in real-time) by the data product system 12 to generate the data product(s). However implemented, the remote data repository 20 is remote in the sense that it is remote from the vehicles 14, but in some embodiments may be co-located with the data product system 12 (as shown) and/or with the OEM gateway 22. The remote data repository 20 may be, for example, one or more databases, data lakes, data warehouses, or some combination thereof. The OEM data lake 21 is also considered a remote data repository in the sense that it is remote from the vehicles 14.

In some embodiments, the OEM may provide the data product system 12 with direct access to the vehicles; for example, by enabling direct streaming of data, such as obtained (current) geographical locations, from the vehicles 14 to the data product system 12, rather than via the OEM gateway 22 (and/or optional OEM data lake 21). This may be done by providing the data product system 12 the necessary credentials and access to the vehicles' communications system 104, and techniques for doing that will be known to those skilled in the art.

The OEM gateway 22 is a computer system that operates as an interface between the vehicles 14 and the data product system 12. The OEM gateway 22 may be operated, managed, owned, and/or controlled (collectively “managed”) by an OEM. The OEM gateway 22 may be implemented as computer instructions that are executed by one or more computers or computing devices. In one embodiment, the OEM gateway 22 is configured to receive requests from the data product system 12 and to determine whether to grant or forward those requests to one or more of the vehicles 14. The OEM gateway 22 may implement certain rules or logic to determine whether a particular request from the data product system 12 should or should not be granted.

The data product system 12 is a centralized or distributed computer system that is used to generate one or more data products based on processed connected vehicle data, where the processed connected vehicle data is derived from obtained geographical locations of the vehicles 14. In at least some embodiments, the data product system 12 is operated, managed, owned, and/or controlled by a data product party, which is a party that is separate than the OEM that manages the OEM gateway 22. The data product system 12 is shown as including the remote data repository 20 as well as a computing device 34 having an electronic processor 36 and computer-readable memory 38. As used herein an “electronic processor” is a physical processing device that operates under electrical power to execute computer instructions. These computer instructions are stored on the computer-readable memory 38 which is accessible by the electronic processor 36 so that the electronic processor 36 may execute the computer instructions. Although the data product system 12 is illustrated as including a single computing device 34, it should be appreciated that, in other embodiments, the data product system 12 includes a plurality of computing devices 34, each of which has an electronic processor and computer-readable memory. Moreover, in at least some embodiments, the data product system 12 may be provisioned across numerous instances and the functionality described herein as being carried out by the data product system 12 may be carried out in a distributed fashion, such as by one or more computing devices that may or may not be co-located with one another. And, according to some embodiments, the computing device 34 of the data product system 12 may be located remotely from the remote data repository 20 or, in other embodiments, may be co-located with the remote data repository 20. Additionally, it should be appreciated that the computer instructions of the data product system 12 may be stored on one or more memories and/or executed by one or more electronic processors, even though FIG. 1 depicts a single electronic processor and memory.

The plurality of vehicles 14 is illustrated as including at least the first vehicle 16 and the second vehicle 18, each of which is depicted in the illustrated embodiment as a passenger car, but it should be appreciated that any other vehicle including motorcycles, trucks, sports utility vehicles (SUVs), recreational vehicles (RVs), other vehicles or mobility devices that can be used on a roadway or sidewalk, boats, other marine vessels, planes, unmanned aerial vehicles (UAVs), other aerial vehicles, etc., can also be used. Although FIG. 1 only depicts two vehicles 16, 18, it should be appreciated that the vehicles 14 may include any number of vehicles. In some embodiments, the data product system 12 is used to generate data products having data aggregated from information concerning a large number of vehicles and, in such embodiments, the communications system 10 may include a multitude of vehicles, which, as used herein, means at least one thousand (1,000) vehicles.

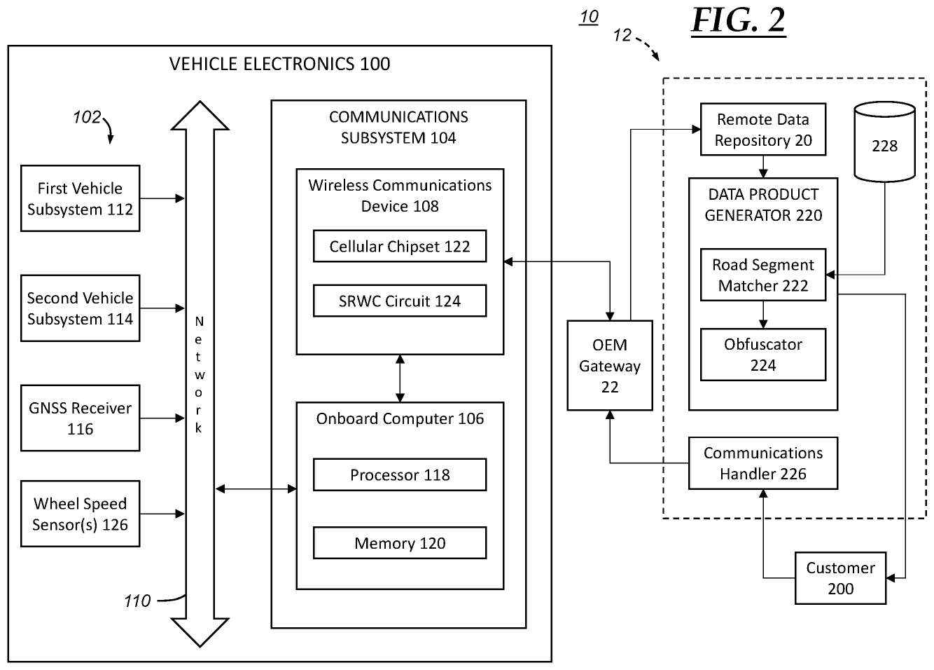

With reference to FIG. 2, there are shown detailed portions of the communications system 10, including vehicle electronics 100 that may be used as a part of the vehicles 14. The vehicle electronics 100 are electronics that include one or more subsystems and/or components that are installed on a vehicle, such as the first vehicle 16 and the second vehicle 18. Although FIG. 2 depicts certain components and subsystems as being a part of the vehicle electronics 100, it should be appreciated that the vehicle electronics 100 may include various other components and/or subsystems in addition to or in lieu of those components and subsystems specifically shown in FIG. 2.

The vehicle electronics 100 includes a plurality of vehicle subsystems 102, a communications subsystem 104 having an onboard computer 106 and a wireless communications device 108, a communications network 110, a global navigation satellite system (GNSS) receiver 116, and one or more wheel speed sensors 126. The plurality of vehicle subsystems 102 is shown as including a first vehicle subsystem 112 and a second vehicle subsystem 114; however, it should be appreciated that, in other embodiments, the plurality of vehicle subsystems 102 may include any suitable number of vehicle subsystems. In one embodiment, the first vehicle subsystem 112 may be an engine controller and the second vehicle subsystem 114 may be a body computer. Of course, any vehicle subsystem that provides data over the vehicle's bus (e.g., over communications network 110) or that otherwise provides data accessible by the communications subsystem 104 may be used.

The communications subsystem 104 includes the wireless communications device 108 and is connected within the vehicle electronics 100 such that the data from the vehicle subsystems 102 is accessible by the communications subsystem 104. It should be appreciated that, although various processing of the communications subsystem 104 and/or the vehicle electronics 100 is described as being carried out by the onboard computer 106, in one or more embodiments, the processing described herein as being attributed to the onboard computer 106 may be carried out by one or more other computers of the vehicle electronics 100, including those that may or may not be considered as forming a part of the communications subsystem 104. Moreover, although the onboard computer 106 is shown and described as being separate from the wireless communications device 108, in one embodiment, the onboard computer 106 and the wireless communications device 108 are integrated into a single device. Also, although the onboard computer 106 and the wireless communications device 108 are illustrated as being directly coupled to one another, in other embodiments, the onboard computer 106 and the wireless communications device 108 may be coupled to each other via the communications network 110 or other suitable electronic communication connection.

The onboard computer 106 includes an electronic processor 118 and computer-readable memory 120. The memory 120 is operatively coupled to the electronic processor 118 so that the electronic processor 118 may access contents of the memory 120, including in-vehicle computer instructions. The electronic processor 118 is configured to execute the in-vehicle computer instructions, which, in at least one embodiment, cause geographical locations of the vehicle to be obtained and then streamed to a remote data repository or system so that this information may be accessible by the data product system 12. In at least some embodiments, the in-vehicle computer instructions may operate to provide a connected vehicle data stream, which is a data stream that includes a succession of a plurality of obtained (current) geographical locations of the vehicle. In some embodiments, in addition to causing the connected vehicle data stream to be streamed to a remote data repository or system, the in-vehicle computer instructions, when executed, may cause the vehicle electronics 100 to obtain vehicle state information, such as wheel speed data obtained or derived from one or more wheel speed sensors 126 or other vehicle speed data indicating a current vehicle speed, and to send that information to a remote data repository or system so that data is accessible by the data product system 12. The vehicle state information may be sent separately from the connected vehicle data stream or, in other embodiments, may be sent as a part of or along with the connected vehicle data stream.

The wireless communications device 108 is used to provide remote network connectivity to the vehicle electronics 100. The wireless communications device 108 is illustrated as including a cellular chipset 122 and a short range wireless communication (SRWC) circuit 124. However, in other embodiments, the wireless communications device 108 may include only one of the cellular chipset 122 and the SRWC circuit 124. Long-range or remote data communications may be carried out by the wireless communications device 108, such as for purposes of transmitting streaming data to the remote data repository 20. The cellular chipset 122 may be used to provide internet connectivity to the vehicle electronics 100 through establishing communications with the cellular tower 28 of the wireless carrier system 26.

The SRWC circuit 124 enables the vehicle to send and receive wireless messages using one or more SRWC technologies, such as Wi-Fi™, Bluetooth™, IEEE 802.11p, other vehicle to infrastructure (V2I) communications, vehicle to vehicle (V2V) communications, other vehicle to everything (V2X) communications, etc. In one embodiment, the SRWC circuit 124 may be used to connect to a wireless access point hosted by another device, such as a wireless communication device included as a part of roadside equipment or a wireless router located at a vehicle user's residence, which may then provide internet or remote network connectivity. For example, the SRWC circuit 124 may transmit data from the vehicle to the remote data repository 20 and/or the OEM gateway 22 via a Wi-Fi™ connection between the wireless communications device 108 and a wireless router/modem, which is then connected to the internet, such as by way of land network 24.

The communications network 110 is an in-vehicle communications network that communicatively couples two or more components or subsystems of the vehicle electronics 100 to each other so that the two or more components may carry out communications. In the illustrated embodiment of FIG. 2, the communications network 110 is shown as communicatively coupling each of the plurality of subsystems 102 to the communications subsystem 104 and, specifically, the onboard computer 106. In one embodiment, the communications network 110 is implemented as one or more hardwired communication network busses, such as those used for providing a controller area network (CAN), a media oriented system transfer (MOST), a local interconnection network (LIN), a local area network (LAN), and/or other appropriate networks, such as those that use Ethernet or others that conform with known ISO, SAE and IEEE standards and specifications, to name but a few. In one embodiment, the communications network 110 may be implemented as a wireless LAN that uses Wi-Fi™, other IEEE 802.11 technology, or other suitable wireless networking technology.

The global navigation satellite system (GNSS) receiver 116 includes hardware enabling the GNSS receiver 116 to receive GNSS signals transmitted by a constellation of GNSS satellites (not shown). In some embodiments, the GNSS receiver 116 may be a global positioning system (GPS) receiver that receives GPS signals from GPS satellites that are a part of the United States' GPS satellite system. GNSS receivers for use with GLONASS, Europe's Galileo system, or other global positioning system may also be used as the GNSS receiver 116. The GNSS receiver 116 uses the received GNSS signals to obtain GNSS data, which may specify a current geographical location of the vehicle. In at least some embodiments, this obtained (current) geographical location is specified as a latitudinal and longitudinal coordinate pair. The obtained geographical location may be periodically determined by the GNSS receiver 116 and transmitted over the communications network 110 so that other components of the vehicle electronics 100, such as the onboard computer 106, may obtain the obtained geographical location of the vehicle.

The wheel speed sensor(s) 126 are each a sensor that is coupled to a wheel and that provides a rotational speed of the respective wheel. The rotational speeds from various wheel speed sensor(s) can then be used to obtain a linear vehicle speed. It should be appreciated that other information, such as other sensor data, may be used along with the rotational wheel speed to determine the linear vehicle speed of the vehicle. The wheel speed sensor(s) 126 can include a tachometer that is coupled to a vehicle wheel and/or other rotating member. In some embodiments, wheel speed sensor(s) 126 can be referred to as vehicle speed sensor(s) (VS S) and can be a part of an anti-lock braking (ABS) system of the vehicle 12 and/or an electronic stability control program. In other embodiments, other sensors or components of the vehicle electronics 100 may be used to determine the vehicle speed.

In one embodiment, the onboard computer 106 is configured to obtain certain data communicated over the communications network 110 and, in a particular embodiment, to obtain certain data provided over one or more hardwired communication network busses. In particular, the onboard computer 106 may be configured to obtain a current geographical location from the GNSS receiver 116 and then cause this obtained (current) geographical location to be streamed by the wireless communications device 108. According to at least some embodiments, the onboard computer 106 is configured to periodically obtain a current geographical location and transmit the obtained (current) geographical location to a remote system or data repository. And, in some embodiments, the onboard computer 106 is configured to periodically obtain vehicle state information, such as a vehicle speed derived from sensor data from the wheel speed sensor(s) 126, and transmit the vehicle state information to a remote system or data repository.

As is also shown in FIG. 2, the data product system 12 includes a data product generator 220, a communications handler 226, and a road segment data store 228. The data product generator 220 includes a road segment matcher 222 and an obfuscator 224, and the data product generator 220 is used to transform data obtained or derived from the remote data repository 20 into one or more data products, which may then be provided to the data product customer 200. As used herein, a “data product” is data derived or otherwise obtained from a collection of data streamed as a part of one or more data streams that are transmitted from a group of vehicles to a remote data repository. In some embodiments the data product is containerized or packaged data according to a custom or standardized format or protocol. In one embodiment, various processing may be performed on the data of the data streams for purposes of obtaining data to be included as a part of the data product. For example, the data product generator 220 may obtain data stored in the remote data repository 20 and/or a part of a data stream and perform various processing, such as obfuscation and/or analytics, on this obtained data so as to generate processed data that is then packaged into a data product. In other embodiments, the data product generator 220 may receive processed data from another device, module, or system that obtains and processes data stored in the remote data repository 20 and/or received as a part of a data stream. And, in some embodiments, the data product generator 220 may receive processed data and also carry out further processing on this processed data, the result of which may then be included in the data product.

The data product generator 220 is shown as including the road segment matcher 222, which is used to identify a road segment from the plurality of road segments based on a received geographical location and to determine an associated road type of the identified road segment. The road segment matcher 222 may access the road segment data store 228, which is a database, data lake, or other data store or repository that includes information or data concerning a plurality of road segments, where each road segment is defined by at least two geographical locations. The road segment data store 228 may also include various other information that may or may not be used as a part of the methods described below. In one embodiment, including in the illustrated embodiment, the road segment data store 228 is included as a part of the data product system 12 and, in some embodiments, may be co-located with the data product generator 220. In one embodiment, the road segment data store 228 is separate and distinct from the remote data repository 20; however, in other embodiments, the road segment data store 228 may be included as a part of the remote data repository 20. In other embodiments, the road segment data store 228 is managed or operated by a different party, such as the OEM or OpenStreetMap™.

The data product generator 220 is also shown as including the obfuscator 224, which is used to determine whether to obfuscate a received geographical location based at least in part on an associated road type; and when it is determined to obfuscate the received geographical location, obfuscate the received geographical location so as to obtain an obfuscated geographical location. In some embodiments, the data product generator 220 may be used to determine whether to include a received geographical location in or exclude a received geographical location from a data product. In such embodiments, this determination may be performed by the obfuscator 224 or may be performed by another module of the data product generator 220. As will be discussed in more detail below, the associated road type may be obtained from the road segment data store 228 based on the received geographical location, which is a geographical location that is received from a vehicle and the received geographical locations may be the same as or derived from the obtained (current) geographical locations that are obtained through use of the GNSS receiver 116.

The communications handler 226 is used to carry out communications with the OEM gateway 22 and/or one or more of the vehicles 14. The communications handler 226 may be used for receiving data product request data from the data product customer 200. The data product request data may be data indicating which data is to be (or requested to be) included in a data product that is requested by the data product customer 200. The data product request data may be provided to the communications handler 226 directly from the data product customer 200, such as through an application programming interface (API), or may be provided from the data product customer 200 to a person of the party managing the data product system 12. In the latter case, the person may input the data product request data into the data product system 12 such that it is accessible by the communications handler 226.

The communications handler 226 may initiate a request to be sent to a subset of the vehicles 14 directly by sending the request to the subset of vehicles. In other embodiments, the communications handler 226 may initiate a request to be sent to a subset of the vehicles 14 by sending one or more messages to the OEM gateway 22, which may deny or grant the request. If granted, the OEM gateway 22 may then send the request to the subset of vehicles. The request, when received at the subset of vehicles, may cause each of the subset of vehicles to make a change to a data stream, such as to change the data capture and/or transmission rate, to change which data is being sent, or some combination thereof.

Each of the data product generator 220, the road segment matcher 222, the obfuscator 224, and the communications handler 226 may be implemented as executable computer instructions that, when executed by one or more electronic processors of the data product system 12 (e.g., the electronic processor 36 of the computing device 34), cause the data product system 12 to carry out the functionality described herein as being attributed to the data product generator 220, the road segment matcher 222, the obfuscator 224, and the communications handler 226, respectively. Specifically, for example, the data product system 12 may include obfuscator computer instructions that, when executed, cause the functionality attributed to the obfuscator 224 to be carried out.

Any one or more of the electronic processors discussed herein may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the non-transitory, computer-readable memory discussed herein may be implemented as any suitable type of memory that is capable of storing data or information in a non-volatile manner and in an electronic form so that the stored data or information is consumable by the electronic processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or computing devices may include other memory, such as volatile RAM that is used by the electronic processor, and/or may include multiple electronic processors.

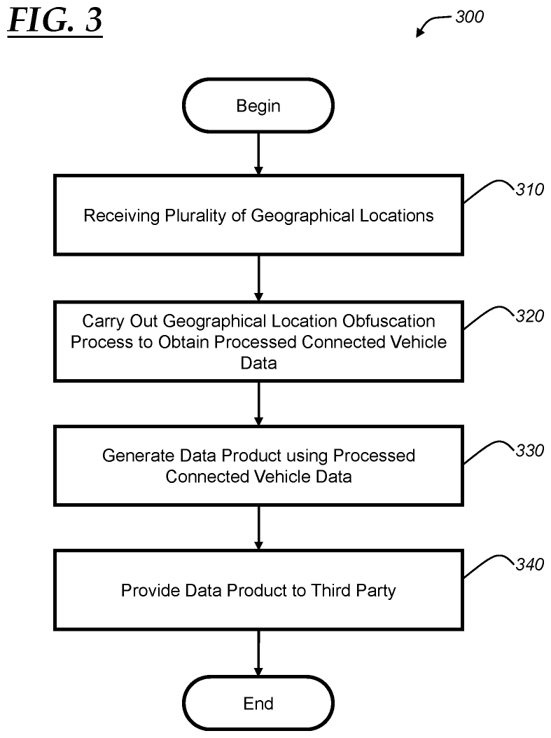

With reference to FIG. 3, there is shown an embodiment of a method 300 of generating and providing a data product using data supplied by a multitude of vehicles. According to at least some embodiments, the method 300 is carried out by the data product system 12 and, in particular, the data product system 12 includes one or more electronic processors (including the electronic processor 36) that are configured to execute data product computer instructions that, when executed by the one or more electronic processors, cause the data product system 12 to carry out the method 300.

The method 300 begins with step 310, wherein a plurality of connected vehicle data sets is received. The connected vehicle data sets include a plurality of received geographical locations, which may be obtained (current) geographical locations that were determined or otherwise obtained by the vehicles 14. In at least one embodiment, each of the vehicles 14 periodically obtains a current geographical location, which may be based on GNSS data obtained by the GNSS receiver 116, and transmits the obtained (current) geographical location as part of a connected vehicle data set to a remote system or data repository, such as the remote data repository 20 or the OEM data lake 21. After being received at the remote system or data repository, the obtained (current) geographical locations are referred to as received geographical locations. The received geographical location specifies the location of the vehicle at a particular time and, in some embodiments, the received geographical location may be of a first resolution or precision, such as +/−3 meters. In at least one embodiment, the received geographical location is specified as a latitudinal and longitudinal coordinate pair.

At least according to some embodiments, the method 300 may be used to provide a real-time data product. In such a case, each of the plurality of connected vehicle data sets may be transmitted from a vehicle continuously and in real-time, and then accessed or otherwise received at the data product system 12 as soon as the connected vehicle data set is available, which may be as soon as the connected vehicle data set is stored at the remote data repository or other data store. In some embodiments, the connected vehicle data sets are each a part of a connected vehicle data stream transmitted by a vehicle. And, in some embodiments, the connected vehicle data sets may be sent directly to the data product system 12 and/or stored in a temporary data store or buffer, which may be a part of the data product system 12. In such embodiments, the data product generator 220 (or other portion of the data product system 12) may access the temporary data store or buffer, and may then obtain and process the next connected vehicle data set. This connected vehicle data set may then be removed from the temporary data store or buffer. In other embodiments, the connected vehicle data streams may be fed to a remote data repository, such as the remote data repository 20 or OEM data lake 21, for long-term storage and then the data product generator 220 (or other portion of the data product system 12) may access and, thus, receive the connected vehicle data sets. The method 300 continues to step 320.

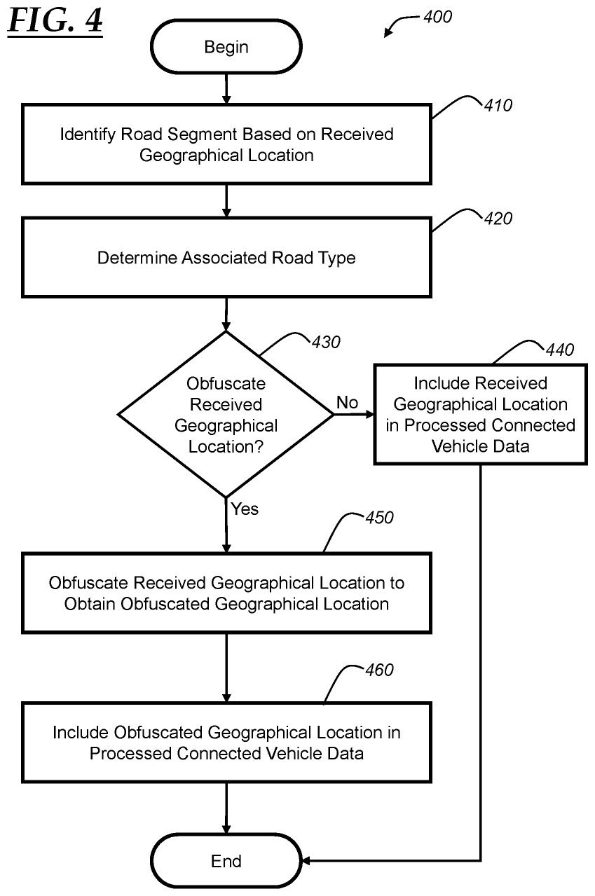

In step 320, a geographical location obfuscation process is carried out. An embodiment of a geographical location obfuscation process is depicted in FIG. 4 and described below. The geographical location obfuscation process includes processing each of the received geographical locations contained in the plurality of connected vehicle data sets so as to obtain processed connected vehicle data, which may then be used to generate a data product. In particular, and according to at least one embodiment, the geographical location obfuscation process may be continuously carried out as the received geographical locations are received and an iteration of the steps 410-440 may be carried out for a received geographical location in response to receiving the received geographical location at the data product system 12—that is, an iteration of the steps 410-440 may be carried out for each of the plurality of received geographical locations. The processed connected vehicle data resulting from one or more iterations of the geographical location obfuscation process may include one or more obfuscated geographical locations as well as one or more (non-obfuscated) geographical locations. In some embodiments, thousands, if not millions, of iterations of the steps 410-440 are carried out. The method 300 continues to step 330.

In step 330, a data product is generated using the processed connected vehicle data. In some embodiments, such as where the data product is a real-time data product, the processed connected vehicle data may be continuously updated as a result of continuously carrying out the geographical location obfuscation process in response to receiving the connected vehicle data sets that include the received geographical locations. The data product may thus include processed connected vehicle data, or data derived therefrom, that is continuously updated to reflect the connected vehicle data sets as they are continuously received at the data product system. In this sense, the real-time data product is a streaming data product that is continuously updated in response to receiving connected vehicle data sets from the vehicles 14. In one embodiment, the data product generator 220 obtains the processed connected vehicle data that was stored at the remote data repository 20, and then includes this processed connected vehicle data in the data product. In another embodiment, the processed connected vehicle data, which may be stored at the remote data repository 20 and/or OEM data lake 21, may first be processed, such as for calculating analytics describing the connected vehicle data, by another device or system and this processed data derived from the processed connected vehicle data may then be included in the data product. The method 300 continues to step 340.

In step 340, the data product is provided to a third party. Once or as the data product is assembled or otherwise generated, the data product may be provided to the data product customer 200, such as through electronically transmitting the data product to a computing device used by the data product customer 200 or by making the data product available to the data product customer 200, such as by sending a download or access URL to the data product customer 200 that enables the data product customer 200 to download or otherwise access the data product. In one embodiment, the data product system 12 transmits the data products to the third party computer system or, in another embodiment, the data product system 12 provides a download or access link to the third party or third party computer system that is usable to access and/or download the data product. The method 300 then ends.

With reference to FIG. 4, there is shown an embodiment of a geographical location obfuscation process 400. As mentioned above, according to at least one embodiment, the geographical location obfuscation process 400 may be continuously carried out as the connected vehicle data sets, which include obtained geographical locations of the vehicles, are received and an iteration of the steps 410-440 may be carried out for each received geographical location (i.e., an obtained geographical location that is received at the data product system) in response to receiving the connected vehicle data sets at the data product system 12.

The process 400 begins with step 410, wherein a road segment is identified based on a received geographical location. Various map matching techniques may be used to identify a road segment based on the received geographical location. In one embodiment, the road segment is identified based on determining which of a plurality of road segments corresponds closest in geographical proximity to the received geographical location. In such an embodiment, for example, the received geographical location is compared to a start node of each of the plurality of road segments and, after determining which start node is closest in geographical proximity to the received geographical location, then the corresponding road segment having the closest start node is identified as the road segment. The process 400 continues to step 420.

In step 420, an associated road type of the road segment is determined. The associated road type is a road type that is associated with the road segment identified in step 410. The road type specifies a type of road or other automobile throughway. In some embodiments, the road type specifies a type of “highway” as that term is used by OpenStreetMap™. The “highway” road type may be any of a motorway, trunk, primary, secondary, tertiary, unclassified, or residential, as those terms are used by OpenStreetMap™. Additionally, in one embodiment, the road type may be any of a motorway_link, trunk_link, primary_link, secondary_link, tertiary_link, living_street, service, pedestrian, track, bus_guidway, escape, raceway, road, or busway, as those terms are used to denote a particular type of OpenStreetMap™ “highway”. A table describing highway road types as defined by OpenStreetMap is provided below. The process 400 continues to step 430.

TABLE 1
Types of “Highways” from OpenStreetMap ™

| | |
|---|---|
| motorway | A restricted access major divided highway, normally with 2 or more running |
| | lanes plus emergency hard shoulder. Equivalent to the Freeway, Autobahn, |
| | etc. |
| trunk | The most important roads in a country's system that aren't motorways. |
| | (Need not necessarily be a divided highway) |
| primary | The next most important roads in a country's system. (Often link larger |
| | towns) |
| secondary | The next most important roads in a country's system. (Often link towns) |
| tertiary | The next most important roads in a country's system. (Often link smaller |
| | towns and villages) |
| unclassified | The least important through roads in a country's system - i.e. minor roads |
| | of a lower classification than tertiary, but which serve a purpose other than |
| | access to properties. (Often link villages and hamlets) |
| | The word ‘unclassified’ is a historical artefact of the UK road system and |
| | does not mean that the classification is unknown; you can |
| | use highway = road for that. |
| residential | Roads which serve as an access to housing, without function of connecting |
| | settlements. Often lined with housing. |
| motorway_link | The link roads (sliproads/ramps) leading to/from a motorway from/to a |
| | motorway or lower class highway. Normally with the same motorway |
| | restrictions. |
| trunk_link | The link roads (sliproads/ramps) leading to/from a trunk road from/to a |
| | trunk road or lower class highway. |
| primary_link | The link roads (sliproads/ramps) leading to/from a primary road from/to a |
| | primary road or lower class highway. |
| secondary_link | The link roads (sliproads/ramps) leading to/from a secondary road from/to |
| | a secondary road or lower class highway. |
| tertiary_link | The link roads (sliproads/ramps) leading to/from a tertiary road from/to a |
| | tertiary road or lower class highway. |
| living_street | Residential streets where pedestrians have legal priority over cars, speeds |
| | are kept very low and where children are allowed to play on the street |

In step 430, it is determined whether to obfuscate the received geographical location based at least in part on the associated road type. In one embodiment, this determination is made based on comparing the associated road type of a predetermined list of road types. For example, the associated road type is compared to a predetermined list of road types and, when the associated road type matches one of the road types in the list of road types, then it is determined that the received geographical location is to be obfuscated. In one embodiment, the list of road types includes residential road types, which includes both the “residential” and “living_street” types of highways as specified by OpenStreetMap™. As another example, the associated road type is compared to a predetermined list of road types and, when the associated road type matches one of the road types in the list of road types, then it is determined that the received geographical location is not to be obfuscated. In other embodiments, the determination of whether to obfuscate the received geographical location is performed in another manner.

In some embodiments, step 430 of the process 400 may include determining whether to obfuscate the received geographical location based at least in part on a vehicle speed, such as a linear vehicle speed. As a part of each vehicle periodically and continuously transmitting an obtained (current) geographical location, the vehicle may also periodically and/or continuously transmit vehicle speed information. The vehicle speed information may specify a vehicle speed of the vehicle, such as a wheel speed of the vehicle or a linear vehicle speed. As discussed above, in some embodiments, the determination of whether to obfuscate the received geographical location may be based solely on the associated road type of the road segment. However, in other embodiments, this determination may further be based on a vehicle speed as indicated by vehicle speed information. For example, when it is determined that the linear vehicle speed is below a particular threshold amount (e.g., 15 miles per hour) and the associated road type is or corresponds to a residential road type, then it may be determined to obfuscate the received geographical location and, if these conditions are not true, then to not obfuscate the received geographical location but to instead proceed to step 440. In other embodiments, the determination of step 430 may be made based in part on other vehicle state information, such as certain vehicle sensor data that may be communicated over a hardwired vehicle communications bus or otherwise communicated over the communications network 110. If it is determined to obfuscate the received geographical location, the process 400 continues to step 450; otherwise, the process 400 continues to step 440.

In step 440, the received geographical location is included in processed connected vehicle data. The processed connected vehicle data is data specifying one or more locations, and may include one or more received geographical locations and/or one or more obfuscated geographical locations. The processed connected vehicle data may be used to generate a data product, which is discussed above in step 330 of the method 300. The received geographical location may be of a particular precision or resolution, such as +/−3 meters. The process 400 then ends and/or may loop back to step 410 for further execution in order to process another received geographical location.

In step 450, the received geographical location is obfuscated so as to obtain an obfuscated geographical location. The obfuscated geographical location is an obfuscated representation of the received geographical location of the vehicle. As used herein, obfuscation or its other forms refers to modifying the received geographical location so as to reduce the resolution or precision of the received geographical location, or to otherwise conceal or obfuscate the received geographical location. For example, according to one embodiment, the received geographical location may be initially determined or obtained as an obtained (current) geographical location at the vehicle, such as by the GNSS receiver 116 and may be of a particular resolution, such as +/−3 meters. Then, as a part of this step, the received geographical location may be obfuscated so as to generate or otherwise obtain an obfuscated geographical location that is the received geographical location but with reduced resolution, such as +/−1000 meters. In one implementation, for example, the obfuscated geographical location may be generated by removing one or more significant figures from the lowest decimal place(s). For example, assuming the received geographical location is a latitudinal-longitudinal coordinate pair of 45.12345, 35.12345, the obfuscated geographical location may be determined as being a latitudinal-longitudinal coordinate pair of 45.12, 35.12. Here, three digits were removed and the resolution of the latitudinal-longitudinal coordinate pair of the obfuscated geographical location is less than the resolution of the latitudinal-longitudinal coordinate pair of the received geographical location.

In another embodiment, an obfuscated geographical location is generated based on the received geographical location, but the resolution specified by the obfuscated geographical location may be the same as the resolution of the received geographical location. For example, assuming the received geographical location is a latitudinal-longitudinal coordinate pair of 45.12345, 35.12345, the obfuscated geographical location may be determined as being a latitudinal-longitudinal coordinate pair of 45.12754, 35.12986. In this example, the obfuscated geographical location and the received geographical location have the same resolution, but the last three digits of the obfuscated geographical location were randomly (or pseudorandomly) generated so as to conceal the actual location of the received geographical location. In yet another embodiment, the obfuscated geographical location may be set as an identifier or associated geographical region (e.g., zip code) in which the received geographical location resides. The process 400 continues to step 460.

In step 460, the obfuscated geographical location is included in processed connected vehicle data. As mentioned above, the processed connected vehicle data is data that may include one or more received geographical locations and/or one or more obfuscated geographical locations. The processed connected vehicle data may be used to generate a data product, which is discussed above in step 330 of the method 300. The obfuscated geographical location may be of a first precision or resolution, such as +/−1000 meters, and may be set lower than a second precision or resolution of the received geographical location, which may be, for example, +/−3 meters. The process 400 then ends.

In some embodiments, a graduated geographical location obfuscation process may be used. The graduated geographical location obfuscation process is similar in nature and operation as the geographical location obfuscation process discussed herein; however, in the graduated geographical location obfuscation process, an obfuscation level may be selected as a part of determining whether to obfuscate the vehicle data. For example, when it is determined that the linear vehicle speed is below a particular threshold amount (e.g., 15 miles per hour) and the associated road type is or corresponds to a residential road type, then it may be determined to obfuscate the received geographical location using a first obfuscation level. In this example, when it is determined that the linear vehicle speed is above or equal to a particular threshold amount (e.g., 15 miles per hour) and the associated road type is or corresponds to a residential road type, then it may be determined to obfuscate the received geographical location using a second obfuscation level. And, in this example, when it is determined that the vehicle speed is above or equal to a particular threshold amount (e.g., 15 miles per hour) and the associated road type is not or does not correspond to a residential road type, then it may be determined not to obfuscate the received geographical location but to include the received geographical location in the processed connected vehicle data. Then, in step 450, the received geographical location may be obfuscated according to the selected obfuscation level, which, in the preceding example, may be the first obfuscation level or the second obfuscation level. In one embodiment, the first obfuscation level may be set so that the precision or resolution of the obfuscated geographical location generated using the first obfuscation level is less than the precision or resolution of the obfuscated geographical location generated using the second obfuscation level. For example, assuming the received geographical location is a latitudinal-longitudinal coordinate pair of 45.12345, 35.12345, the obfuscated geographical location that is determined using the first obfuscation level may be a latitudinal-longitudinal coordinate pair of 45.12, 35.12 and the obfuscated geographical location that is determined using the second obfuscation level may be a latitudinal-longitudinal coordinate pair of 45.123, 35.123.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A data product system for generating and providing a data product using data supplied by a multitude of vehicles, wherein each of the multitude of vehicles includes vehicle electronics configured to:
periodically obtain a current geographical location of the vehicle; and
in response to obtaining the obtained geographical location of the vehicle, transmit the obtained geographical location of the vehicle to a remote location;
wherein the data product system comprises one or more electronic processors and memory storing data product computer instructions accessible by the one or more electronic processors of the data product system;
wherein the data product system is configured so that, when the data product computer instructions are executed by the one or more electronic processors of the data product system, the data product system:
receives a plurality of connected vehicle data sets that include a plurality of received geographical locations including the obtained geographical location, wherein each of the plurality of connected vehicle data sets was transmitted by one of the multitude of vehicles;
carries out a geographical location obfuscation process in order to obtain processed connected vehicle data, wherein the geographical location obfuscation process includes processing each of the plurality of received geographical locations by:
identifying a road segment from a plurality of road segments based on the received geographical location;
determining an associated road type of the road segment;
determining whether to obfuscate the received geographical location based at least in part on the associated road type; and
when it is determined to obfuscate the received geographical location, obfuscating the received geographical location so as to obtain an obfuscated geographical location, wherein the obfuscated geographical location is included in the processed connected vehicle data;
generates the data product using the processed connected vehicle data; and
provides the data product to a third party.

2. The data product system of claim 1, wherein the determination of whether to obfuscate the received geographical location includes comparing the associated road type with a predetermined list of road types.

3. The data product system of claim 1, wherein the determination of whether to obfuscate the received geographical location includes determining whether the associated road type is or corresponds to a residential road type.

4. The data product system of claim 1, wherein the obfuscated geographical location is a lower-resolution representation of the received geographical location.

5. The data product system of claim 1, wherein the vehicle electronics are configured to transmit vehicle speed information, and wherein the geographical location obfuscation process includes determining whether to obfuscate the received geographical location based at least in part on the vehicle speed information.

6. The data product system of claim 5, wherein the vehicle speed information indicates a linear vehicle speed of the vehicle.

7. The data product system of claim 6, wherein the geographical location obfuscation process includes, when it is determined that the linear vehicle speed is below a predetermined threshold amount and the associated road type is or corresponds to a residential road type, determining to obfuscate the received geographical location using a first obfuscation level.

8. The data product system of claim 7, wherein the geographical location obfuscation process includes, when it is determined that the linear vehicle speed is above or equal to the predetermined threshold amount and the associated road type is or corresponds to a residential road type, determining to obfuscate the received geographical location using a second obfuscation level, wherein the first obfuscation level is set so that a precision or resolution of the obfuscated geographical location generated using the first obfuscation level is less than a precision or resolution of the obfuscated geographical location generated using the second obfuscation level.

9. The data product system of claim 8, wherein the geographical location obfuscation process includes, when it is determined that the linear vehicle speed is above or equal to the predetermined threshold amount and the associated road type is not or does not correspond to a residential road type, determining not to obfuscate the received geographical location but to include the received geographical location in the processed connected vehicle data.

10. A method of generating and providing a data product using data supplied by a multitude of vehicles, wherein the method is carried out by a data product system comprising one or more electronic processors, and wherein the method comprises the steps of:
receiving a plurality of geographical locations, wherein each of the plurality of received geographical locations was transmitted by one of the multitude of vehicles;
carrying out a geographical location obfuscation process in order to obtain processed connected vehicle data, wherein the geographical location obfuscation process includes processing each of the plurality of received geographical locations by:
identifying a road segment from a plurality of road segments based on the received geographical location;
determining an associated road type of the road segment;
determining whether to obfuscate the received geographical location based at least in part on the associated road type; and
when it is determined to obfuscate the received geographical location, obfuscating the received geographical location so as to obtain an obfuscated geographical location, wherein the obfuscated geographical location is included in the processed connected vehicle data;
generating the data product using the processed connected vehicle data; and
providing the data product to a third party.
